(19) United States
(12) Patent Application Publication
(10) Pub. No.: US 2020/0041828 A1
(43) Pub. Date: Feb. 6, 2020

(54) METHOD OF REMOVING PANEL FROM SUCTION SURFACE, METHOD OF PRODUCING DISPLAY PANEL, AND PANEL CATCHER

(71) Applicant: SHARP KABUSHIKI KAISHA, Osaka (JP)

(72) Inventors: EIJI TSUTSUMI, Osaka (JP); REN UCHIDA, Osaka (JP)

(21) Appl. No.: 16/508,751

(22) Filed: Jul. 11, 2019

Related U.S. Application Data
(60) Provisional application No. 62/712,992, filed on Aug. 1, 2018.

(51) Int. Cl. G02F 1/1347; G02F 1/13

(52) U.S. Cl. CPC G02F 1/1347; G02F 1/1303; G02F 1/1306

(57) ABSTRACT

A method of removing a panel from a suction surface to which the panel is held by suction includes a covering step, a removing step, and a catching step. The a covering includes covering the panel with a panel catcher including a catching surface opposed to an opposite surface that is one of plate surfaces of the panel on an opposite side from the suction surface with a gap. The removing step includes removing the panel from the suction surface by supplying a liquid between the suction surface and the panel covered with the panel catcher. The a catching step includes catching the panel removed in the removing step by attaching the panel to the catching surface.

### CROSS REFERENCE TO RELATED APPLICATION

This application claims priority from U.S. Provisional Patent Application No. 62/712,992 filed on Aug. 1, 2018. The entire contents of the priority application are incorporated herein by reference.

### TECHNICAL FIELD

The technology described herein relates to a method of removing a panel from a suction surface, a method of producing a display panel, and a panel catcher.

### BACKGROUND ART

In recent years, weights and thicknesses of display devices including television sets and portable information devices are decreasing. Because of the reductions in weight and thickness, reductions in weight and thickness of display panels are needed. In preparation of a liquid crystal panel, a glass substrate disposed on an outer side may be polished after a liquid crystal is sealed between two glass substrates on which TFTs and a color filter are provided. The polishing may be performed by rubbing a polishing pad against a surface of the liquid crystal panel (the glass substrate) attached to a suction mat by suction while supplying slurry that is a mixture of abrasives and water. After the polishing, water is sprayed between the liquid crystal panel and the suction mat to remove the liquid crystal panel from the suction mat with the water between the liquid crystal panel and the suction mat. Alternatively, the liquid crystal panel may be directly lifted with hands after the polishing to remove the liquid crystal panel.

According to the method of removing the liquid crystal panel from the suction mat by spraying liquid such as water, the liquid crystal panel may be blown off by the sprayed water when the liquid crystal panel is completely removed from the suction mat. According to the method of removing the liquid crystal panel with hands, a large force is applied to a certain spot. When a load is applied to the liquid crystal panel, the glass substrates that has a reduced thickness from polishing and thus has a reduced strength may be easily chipped or cracked. Furthermore, the liquid crystal panel may be deformed due to the reduced thickness resulting in warp. A collapse may occur due to the warp. An internal structural damage may be easily caused due to the collapse resulting in reduction in image quality.

### SUMMARY

The technology described herein was made in view of the above circumstances. An object is to provide a method of removing a panel that is attached to a suction surface by suction without damage, a method of producing a display panel, and a panel catcher.

The technology described herein relates to a method of removing a panel from a suction surface to which the panel is attached by suction. The method includes a covering step, a removing step, and a catching step. The covering step includes covering the panel with a panel catcher including a catching surface opposed to an opposite surface that is one of plate surfaces of the panel on an opposite side from the suction surface with a gap. The removing step includes removing the panel from the suction surface by supplying a liquid between the suction surface and the panel covered with the panel catcher. The catching step includes catching the panel removed in the removing step by attaching the panel to the catching surface.

The technology described herein relates to a method of producing a display panel. The method includes a suction step, a polishing step, a covering step, a removing step, a catching step, and an ejecting step. The suction step includes attaching the display panel to the suction surface. The polishing step includes polishing one of plate surfaces display panel attached to the suction surface on an opposite side from the suction surface. The covering step includes covering the display panel with a panel catcher including a catching surface opposed to the opposite surface with a gap. The removing step includes removing the display panel from the suction surface by supplying a liquid between the suction surface and the display panel covered with the panel catcher. The catching step includes catching the display panel removed in the removing step by attaching the display panel to the catching surface. The ejecting step includes ejecting the display panel attached to the catching surface from the panel catcher. At least the above steps are performed in sequence.

The technology described herein relates to a panel catcher used for removing a panel from a suction surface to which the panel is attached by suction by supplying a liquid between the suction surface and the panel. The panel catcher includes a covering portion and a vertical wall. The covering portion includes a catching surface that is flat. The vertical wall protrudes from the catching surface and extends along a periphery of the covering portion with a dimension larger than a thickness of the panel. The vertical wall includes an opening through which the liquid is introduced into an inner side than the vertical wall.

According to the technology described herein, the method of removing the panel from the suction surface to which the panel is attached by suction without damage, the method of producing the display panel, and the panel catcher are provided.

### BRIEF DESCRIPTION OF THE DRAWINGS

FIG. 1 is a perspective view illustrating a polisher and a panel catcher according to a first embodiment.

FIG. 2A is a schematic view illustrating a step (a suction step) in a production of a liquid crystal panel.

FIG. 2B is a schematic view illustrating a step (a polishing step) in the production of the liquid crystal panel.

FIG. 2C is a schematic view illustrating a step (a covering step) in the production of the liquid crystal panel.

FIG. 2D is a schematic view illustrating a step (a removing step) in the production of the liquid crystal panel.

FIG. 2E is a schematic view illustrating a step (a removing step) in the production of the liquid crystal panel.

FIG. 2F is a schematic view illustrating a step (a catching step) in the production of the liquid crystal panel.

FIG. 2G is a schematic view illustrating a step (a ejecting step) in the production of the liquid crystal panel.

FIG. 3 is a perspective view illustrating a suction mat and a panel catcher according to a second embodiment.

FIG. 4 is a perspective view of a bottom surface-side of the panel catcher.

FIG. 5 is a perspective view of a bottom surface-side of a panel catcher according to a third embodiment.

FIG. 6 is a perspective view of a bottom surface-side of another embodiment.

### DETAILED DESCRIPTION

### First Embodiment

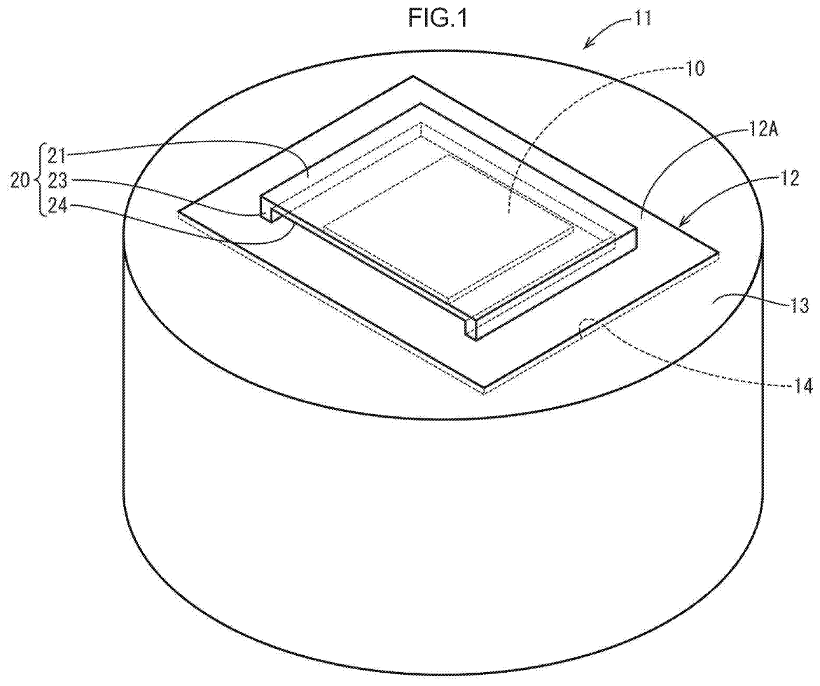

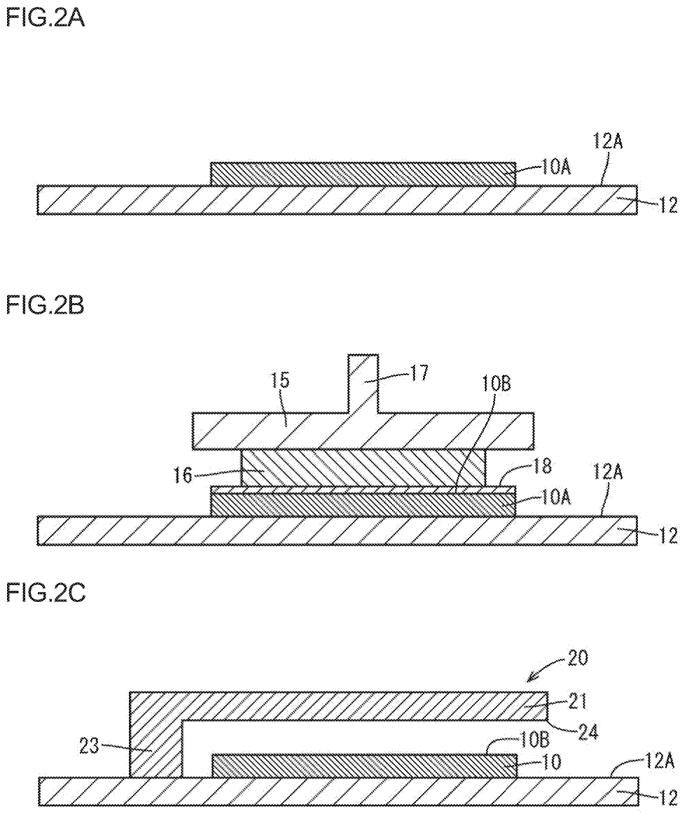

A first embodiment will be described with reference to FIGS. 1 to 2G. A liquid crystal panel 10 (an example of a panel and an example of a display panel) produced by a method according to this embodiment has a known configuration including a pair of transparent glass substrates (having high light transmissivity) and a liquid crystal layer. The glass substrates are bonded together with a predefined gap therebetween. The liquid crystal layer is disposed between the glass substrates. Specifically, one of the glass substrates, source lines, gate lines, switching components (e.g., TFTs), pixel electrodes, and an alignment film are disposed. The source lines and the gate lines are perpendicular to each other. The switching components are connected to the source lines and the gate lines. On the other one of the glass substrates, a color filter, a common electrode, and an alignment film are disposed. The color filter includes red (R), green (G), and blue (B) color portions in predefined arrangement. Image data and various control signals required for displaying images are supplied from a driver circuit board to the source lines, the gate lines, and the common electrode. With the components opposed to each other, liquid crystal is sealed between the glass substrates. In this embodiment, polarizing plates are not disposed on outer surfaces of the glass substrates.

The liquid crystal panel 10 in this embodiment includes the glass substrates that are polished and disposed on the front side and thus has a thickness smaller in comparison to a conventional panel (hereinafter, a liquid crystal panel before polishing will be indicated by reference symbol 10A for the purpose of illustration). A method of producing the liquid crystal panel 10 will be described. As illustrated in FIG. 1, a polisher 11, a portion of which will not be illustrated, includes a stage 13 on which a suction mat 12 is disposed. The stage 13 includes a holding recess 14 that is concave. The suction mat 12 is prepared from a porous soft resin that may be made of formed polyurethane resin. The liquid crystal panel 10A is attached to a suction surface 12A that is the upper surface of the suction mat 12 by vacuum suction (a suction step, see FIG. 2A). The suction surface 12A and the upper surface of the stage 13 are flush with each other.

A rotor 15 is disposed above the liquid crystal panel 10. The rotor 15 includes a polishing pad 16 at a lower end. The polishing pad 16 rotates on a plate surface of the liquid crystal panel 10A by a rotor driving shaft 17 coupled to a driver. The rotor 15 (the polishing pad 16) rotates and rubs on the surface of the liquid crystal panel 10A with slurry that is prepared by dispersing abrasives in the water. As a result, an opposite surface 10B of the liquid crystal panel 10A on an opposite side from the suction surface 12A is polished (a polishing step, see FIG. 2B). Through the polishing, the thickness of the glass substrate is reduced to be in a range from 0.28 to 0.3 mm. Because the liquid crystal panel 10A is rubbed and polished, a suction force between the liquid crystal panel 10A and the suction surface 12A is large so that displacement is not caused by the polishing.

In this embodiment, a panel catcher 20 is used for removing the liquid crystal panel 10 from the suction surface 12A after the polishing step. The panel catcher 20 is made of synthetic resin. The panel catcher 20 has a flat box shape with a size for entirely covering the liquid crystal panel 10 from a side along the plate surface of the liquid crystal panel 10 (see FIG. 1). Specifically, the panel catcher 20 includes a covering portion 21 and vertical walls 23. The covering portion 21 has a rectangular plate shape with a size slightly larger than a two-dimensional size of the liquid crystal panel 10. The vertical walls 23 protrude from three edge portions among four edge portions of the covering portion 21 perpendicularly in one direction. Each of the vertical walls 23 has a thickness slightly larger than the thickness of the liquid crystal panel 10. The adjacent vertical walls 23 are coupled to each other. The vertical walls 23 form a U shape along a periphery of the covering portion 21. An edge of the covering portion 21 from which none of the vertical walls 23 protrudes and two of the vertical walls 23 adjacent to the edge form a gate shape and define an opening 24. An opposite side from the covering portion 21 is open.

Next, a method of removing the liquid crystal panel 10 from the suction mat 12 will be described. The panel catcher 20 is placed on the suction mat 12 to cover the liquid crystal panel after the polishing step (a covering step, see FIGS. 1 and 2C). In this condition, the one of the plate surfaces (a lower surface) of the covering portion 21 of the panel catcher 20 is separated from the opposite surface 10B of the liquid crystal panel 10 (opposed with a gap). A distance between the plate surface and the liquid crystal panel 10 is maintained constant by the vertical walls 23 (hereinafter, the plate surface opposed to the liquid crystal panel will be referred to as a catching surface 22).

Then, a liquid for removal such as water and ethanol is injected between the liquid crystal panel 10 and the suction mat 12 through the opening 24 of the panel catcher 20. In this embodiment, the water is used for the liquid for removal. The suction mat 12 is slightly deformed by a water pressure of the injected water. The injected water enters a gap between the liquid crystal panel 10 and the suction mat 12 created through the deformation (a removing step, see FIG. 2D). The injected water spreads toward the opposite surface 10B and side surfaces 10C of the liquid crystal panel 10. Water droplets are gradually formed on entire areas of the opposite surface 10B and the side surfaces 10C.

It is preferable that the injection of the water is performed with even amount and pressure of water for the entire liquid crystal panel 10 in the width direction (in a direction in which the opening 24 extends). It is preferable to set the amount and the pressure of the water to 5 Mpa and 5 m³/h (3 m³/h with a pressure loss), which may correspond to those of running water from a standard home faucet at full force. However, the amount and the pressure of the water may be altered where appropriate as long as the liquid crystal panel 10 can be removed from the suction mat 12.

As the water enters between the liquid crystal panel 10 and the suction mat 12, the liquid crystal panel 10 is gradually lifted from the suction mat 12 from the edge (the edge to which the water is injected) to the opposite edge. Then, the liquid crystal panel 10 is blown off from a placement position due to the water pressure of the injected water. In this embodiment, the liquid crystal panel 10 that is blown off is caught by the covering portion 21 and the vertical walls 23 of the panel catcher 20. With surface tension of the water on the opposite surface 10B of the liquid crystal panel 10, the liquid crystal panel 10 is attached to the catching surface 22 of the covering portion 21 (a catching step, see FIG. 2F). In comparison to a condition in which the liquid crystal panel 10 is attached to the suction surface 12A by vacuum suction, an attachment force that holds the liquid crystal panel 10 to the suction surface 12A is significantly small.

Finally, the liquid crystal panel 10 that is attached to the catching surface 22 is manually slid toward the opening 24 and ejected through the opening 24 (an ejecting step, see FIG. 2G).

The catching surface 22 may be coated with fluorocarbon polymer. With the fluorocarbon polymer, water repellency is provided and the attachment force is further reduced, which makes the ejection easier. Examples of the fluorocarbon polymer include polytetrafluoroethylene (PTFE) such as Teflon (trademark) and perfluoroalkoxy alkane (PFA).

According to this embodiment, the liquid crystal panel 10 that is attached to the suction surface 12A is gradually removed from the suction surface 12A with the force of the water that enters between the liquid crystal panel 10 and the suction surface 12A through the small gap therebetween. The force is evenly and entirely applied to the liquid crystal panel 10 in the width direction (the direction in which the opening 24 extends). Therefore, a crack due to a large force that is locally applied or an internal structural damage due to collapse caused by warp is less likely to occur.

The liquid crystal panel 10 that may fly away with the water pressure after removed from the suction surface 12A is caught by the panel catcher 20. Therefore, the liquid crystal panel 10 is less likely to be chapped or cracked. Namely, the liquid crystal panel 10 is less likely to have malfunctions.

If the catching surface 22 is coated with the fluorocarbon polymer, the attachment force provided by the surface tension between the liquid crystal panel 10 and the catching surface 22 is lower in comparison to a smooth surface without a fluorocarbon coating. Therefore, the ejection can be more easily performed.

### Second Embodiment

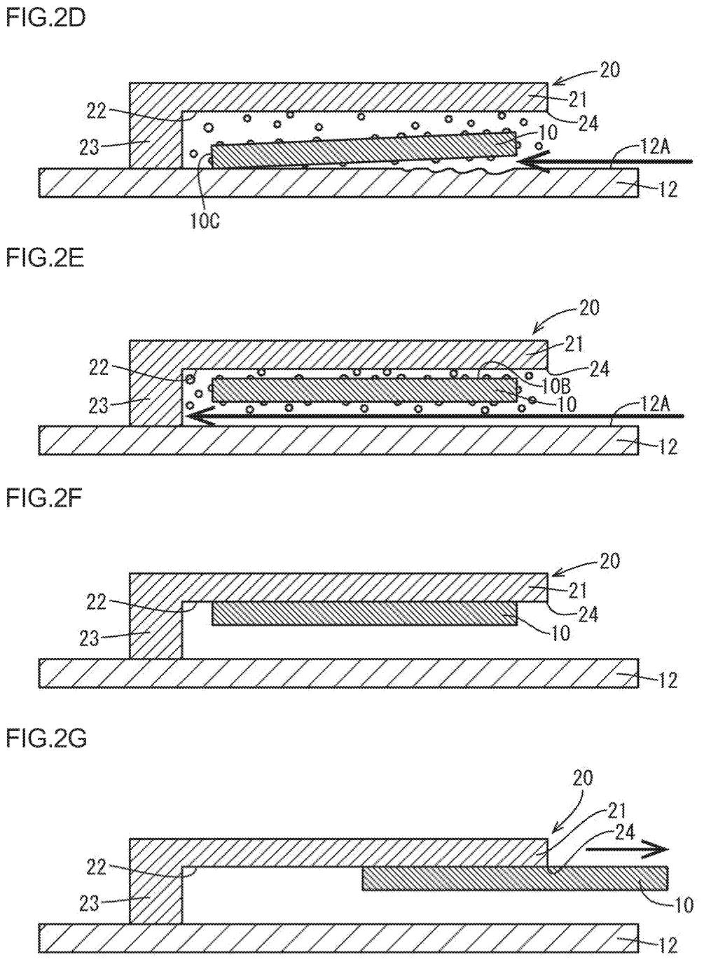

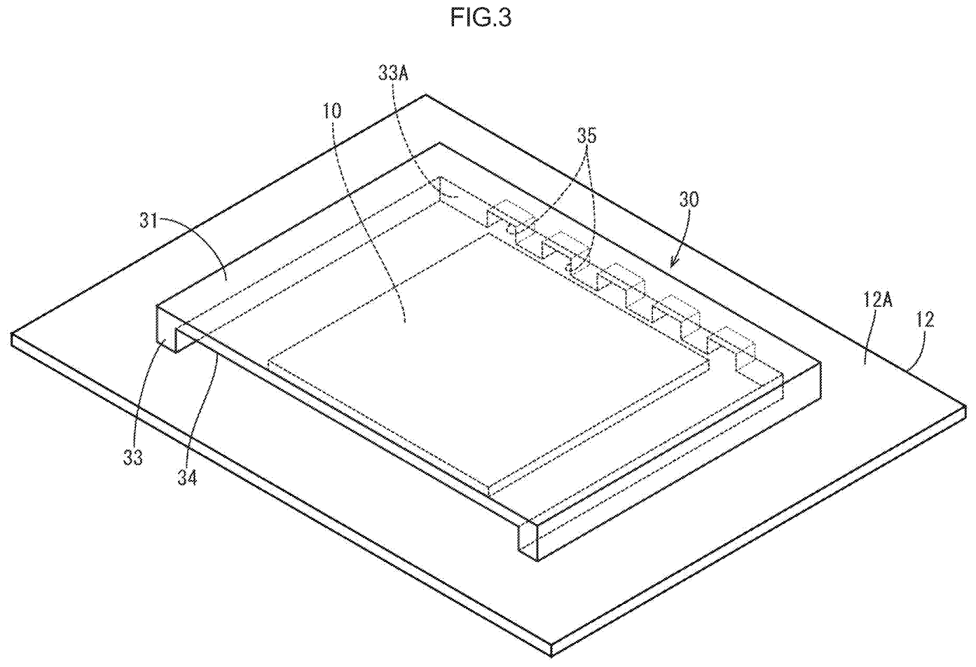

A second embodiment will be described with reference to FIGS. 3 and 4. This embodiment includes a panel catcher including a drain hole in a vertical wall similar to the vertical wall 23 of the panel catcher 20 in the first embodiment. Components different from those of the first embodiment will be described. Components similar to those of the first embodiment will be indicated by reference symbols that are incremented by ten from the reference symbols indicating the components in the first embodiment and may not be described.

The panel catcher 30 in this embodiment includes vertical walls 33 at three edge portions of a covering portion 31. As illustrated in FIG. 4, the vertical wall 33A opposed to an opening 34 includes drain holes 35 for draining some water injected between the liquid crystal panel 10 and the suction mat 12 to the outside.

The drain holes 35 are formed by cutting out portions of the vertical wall 33A closer to an edge apposite from the covering portion 31 to be recessed toward the covering portion 31 and formed in U shapes. Namely, an edge portion of the vertical wall 33A opposed to the opening 34 has a comb shape. Dimensions of the drain holes 35 are defined so that a total area of the holes is set to allow 30% of an amount of the water is drained.

According to the panel catcher 30 in this embodiment, the injected water is drained through the drain holes 35. Unnecessary water is less likely to remain in the panel catcher 30. Therefore, the liquid crystal panel 10 removed from the suction surface 12A is less likely to be removed from a catching surface 32 due to a flow of the water that remains in the panel catcher 30 or to drift toward the opening 34 and come out of the panel catcher 30.

### Third Embodiment

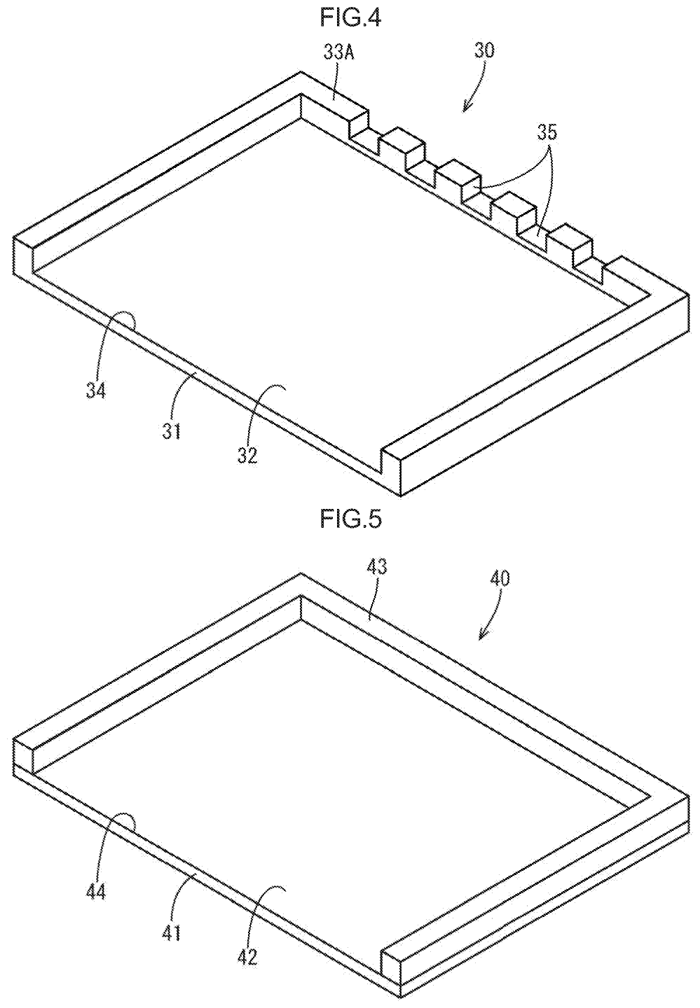

A third embodiment will be described with reference to FIG. 5. In the third embodiment, the vertical walls 23 of the panel catcher 20 included in the first embodiment is altered to be elastic members having elasticity such as rubber. Components different from those of the first embodiment will be described. Components similar to those of the first embodiment will be indicated by reference symbols that are incremented by ten from the reference symbols indicating the components in the first embodiment and may not be described.

As illustrated in FIG. 5, a panel catcher 40 in this embodiment includes three vertical walls 43 perpendicularly extending from three of four edges of a covering portion 41 and being made of rubber (an example of an elastic member). The vertical walls 43 made of rubber include U-shaped members that are arranged along the edges of the covering portion 41 and fixed to one another with adhesives.

According to the panel catcher 40 in this embodiment, when the panel catcher 40 is disposed on the suction mat 12 or the stage 13, a pressure on a placing surface can be absorbed or spread. Therefore, the panel catcher 40 can be easily fit to the placing surface and injected water is less likely to run between the vertical walls 43 and the placing surface and thus to leak to the outside.

### Other Embodiments

The technology described herein is not limited to the embodiments described in the above descriptions and drawings. The following embodiments may be included in the technical scope of the technology described herein.

(1) In each of the above embodiments, the panel catcher 20, 30, or 40 has the configuration to entirely cover the liquid crystal panel 10. However, the configuration of the panel catcher 20, 30, or 40 may be altered to partially cover the liquid crystal panel 10 as long as the panel catcher 20, 30, or 40 can catch the liquid crystal panel 10 that is blown off by the water pressure.

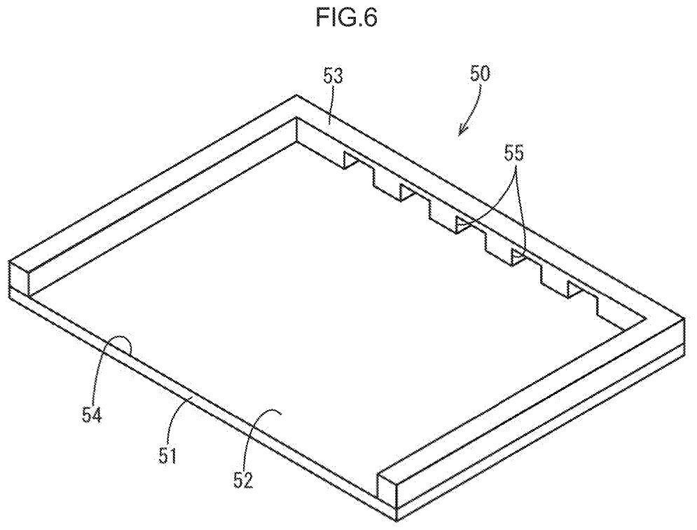

(2) The drain holes 35 are not limited to those in the above embodiments. For example, a single drain hole may be provided. Another example is a panel catcher 50 illustrated in FIG. 6 including through holes formed in a portion of a vertical wall 53 closer to a covering member 51 rather than a distal end of the vertical wall 53. The drain holes 55 can be altered as long as inner dimensions of each drain hole 55 are smaller than the dimensions of the liquid crystal panel 10 so that the liquid crystal panel 10 does not come out.

(3) The vertical wall in which the drain hole(s) are provided is not limited to the one opposed to the opening. The drain hole(s) may be provided in the vertical walls adjacent to the opening.

(4) The substrates in the liquid crystal panel 10 are not limited to the glass substrates. Other types of transparent substrates such as quarts substrates may be used.

(5) The vertical walls may be provided inner than the edge portions of the covering portion instead of the edge portions. The vertical walls may not be in the plate shapes. A configuration including rods that are set out may be included in a technical scope of the technology described herein.

(6) In the third embodiment, the entire vertical walls 43 are prepared from the elastic members. However, distal ends of the vertical walls (on an opposite side from the covering portion) may be prepared from elastic members.

(7) In each of the above embodiments, the liquid crystal panel 10 is provided as an example of a panel. However, the technology described herein can be applied to panels other than the liquid crystal panel 10.

1. A method of removing a panel from a suction surface to which the panel is held by suction, the method comprising:
a covering step of covering the panel with a panel catcher including a catching surface opposed to an opposite surface that is one of plate surfaces of the panel on an opposite side from the suction surface with a gap;
a removing step of removing the panel from the suction surface by supplying a liquid between the suction surface and the panel covered with the panel catcher; and
a catching step of catching the panel removed in the removing step by attaching the panel to the catching surface.

2. A method of producing a display panel, the method comprising:
a suction step of attaching the display panel to a suction surface by suction;
a polishing step of polishing one of plate surfaces of the display panel attached to the suction surface on an opposite side from the suction surface;
a covering step of covering the display panel with a panel catcher including a catching surface opposed to the opposite surface with a gap;
a removing step of removing the display panel from the suction surface by supplying a liquid between the suction surface and the display panel covered with the panel catcher;
a catching step of catching the display panel removed in the removing step by attaching the display panel to the catching surface; and
an ejecting step of ejecting the display panel attached to the catching surface from the panel catcher, wherein
at least the above steps are performed in sequence.

3. A panel catcher used for removing a panel attached to a suction surface by suction from the suction surface by supplying a liquid between the suction surface and the panel, the panel catcher comprising:
a covering portion including a catching surface that is flat; and
a vertical wall protruding from the catching surface and extending along a periphery of the covering portion with a dimension larger than a thickness of the panel, the vertical wall including an opening through which the liquid is introduced into an inner side than the vertical wall.

4. The panel catcher according to claim 3, wherein the vertical wall includes a drain hole for draining the liquid introduced into the inner side than the vertical wall to an outside.

5. The panel catcher according to claim 3, wherein at least an edge portion of the vertical wall on an opposite side from the catching surface is prepared from an elastic member having elasticity.

6. The panel catcher according to claim 3, wherein the catching surface is coated with fluorocarbon polymer.
